(19) United States
(12) Patent Application Publication
(10) Pub. No.: US 2005/0142944 A1
(43) Pub. Date: Jun. 30, 2005

(54) High speed shielded internal cable/connector

(76) Inventors: Yun Ling, Portland, OR (US); Scott Noble, Beaverton, OR (US); Thai D. Tong, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,753

(22) Filed: Dec. 30, 2003

(51) Int. Cl. H01R 13/648

(52) U.S. Cl. 439/608

(57) ABSTRACT

A high speed shielded internal cable/connector is provided. The cable assembly includes a shielded connector on either end of the cable assembly that mates with edge fingers on a motherboard or a daughter card. The one piece card edge style for the cable assembly makes it possible to eliminate the connectors on the motherboard or on the daughter card. The innovative scheme of terminating the cable connector to the system ground makes it possible to shield only the cable assembly and no shielding on the edge fingers.

### BACKGROUND INFORMATION

Typically, internal cable/connectors are unshielded and do not require metal shielding around connectors. One example of an internal cable/connector that is unshielded is ATA. However, if there is a certain amount of EMI emission being generated from the internal cable/connector, then the cable/connector has to meet FCC open box EMI containment requirement. This open box EMI containment requirement states that if a certain amount of EMI emission is being generated then the internal cable/connector will require metal shielding. Thus, a need exists for a low cost, shielded internal cable/connector that meets FCC EMI containment requirement.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a perspective view of a cable assembly of the present invention;

FIG. 2 is a perspective view of a metal can on the cable assembly.

FIG. 3 is an exploded view of edge fingers.

FIG. 4 is an exploded view of the metal can connecting to the edge fingers.

FIG. 5 is a cross-section view of a board header.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

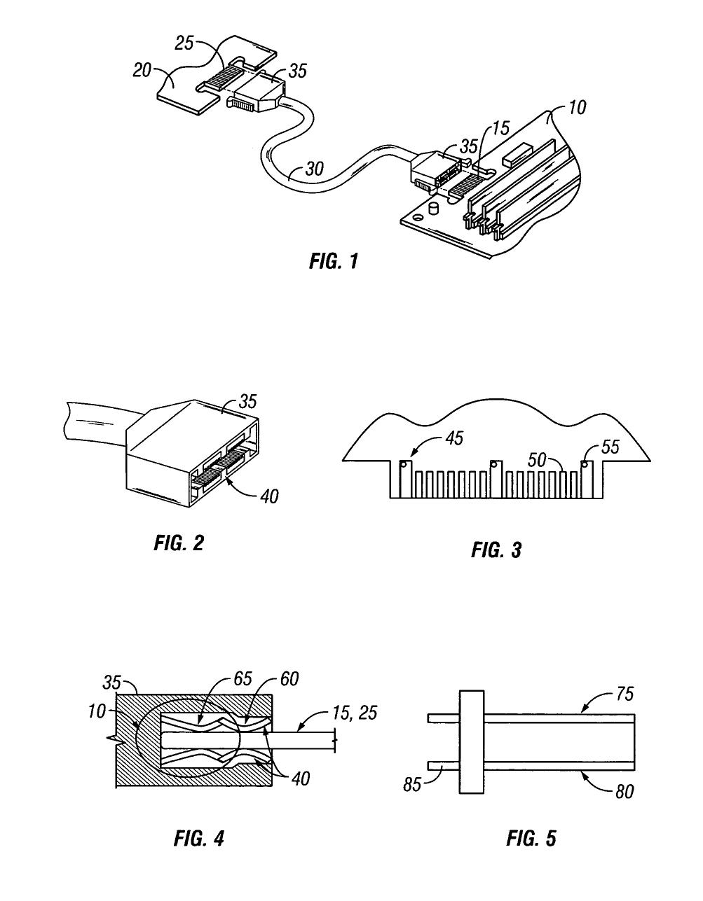

FIG. 1 is a perspective view of a cable assembly of the present invention. A motherboard 10 includes edge fingers 15 and a daughter card 20 includes edge fingers 25. The edge fingers 15, 25 are located directly on the motherboard 10 and the daughter card 20. A cable assembly 30 includes connectors 35 on either end of the cable assembly 30. These connectors 35 are also known as metal cans 35. The connectors 35 directly mate with the edge fingers 15, 25 on the motherboard 10 and the daughter card 20. By having the cable assembly 30 directly mating with the motherboard 10 and the daughter card 20, this eliminates the cost of connectors on the motherboard and the daughter card and the associated assembly cost.

The cable assembly 30 may be shielded with a stamped and formed metal can 35. The cable shielding braid is terminated onto the metal can 35 with the same termination process currently being done for most shielded external cables. This forms a continuous shielding throughout the cable assembly 35.

The metal can 35 on the cable assembly 30 must also be connected to the ground planes on the system motherboard 10 and on the daughter card 20 to complete a return path. FIGS. 2-4 illustrate how the metal can 35 is terminated to the motherboard 10 and the daughter card 20. FIG. 2 illustrates a perspective view of the metal can 35 on the cable assembly 30. The metal can 35 includes compliant spring members 40 that may be stamped and formed on the metal can 35. It should be noted that there are multiple ways to stamp and form spring members 40 out of the metal can, and FIG. 2 illustrates one way.

FIG. 3 is an exploded view of the edge fingers 15, 25 on the motherboard 10 and the daughter card 20. The taller fingers are the ground connections 45 on the edge fingers 15, 25. These ground connections 45 connect to the spring members 40 of the metal can 35 on the cable assembly 30. In this particular example, there are three ground connections 45 on each edge finger 15, 25 to connect to the metal can 35 on the cable assembly 30. However, the number of ground connections 45 can vary depending on the EMI containment needs. The shorter fingers 50 are the contacts for signals, such as the clock signal. There is a difference between the signal contact 50 and the ground connection 45, with the ground connection 45 being extended beyond the signal contacts 50 towards the front end of the cable assembly 30. This is to maximize the EMI performance by containing the electromagnetic field with the metal can 35 as much as possible.

FIG. 4 illustrates how the metal can terminates to the edge fingers on the motherboard and the daughter card. When the cable assembly 30 is plugged into the motherboard 10 or the daughter card 20, the spring members 40 on the metal can 35 mate with the edge finger ground connections 45. These ground connections 45 are connected to a ground plane through vias 55 located on the ground connections 45. When the edge finger 15, 25 is being plugged into the metal can 35, the spring member 40 retracts and enables the edge finger 15, 25 inside the metal can 35. Once inside, various connections can be established between the metal can and ground. These connections may be contact points for shielding 60, contact point for the signal 65 and the contained EMI field 70.

FIG. 5 illustrates an alternative to the cable assembly of FIG. 1. In some instances it may be desirable to bring the interface to the middle of the system board, instead of from the board edge. In these situations, a board header 75 can be made with contact pads 80 similar to the edge fingers shown in FIG. 3. The board header 75 may be placed on the motherboard 10 where it is desirable. The contact pads 80 mate the board header 75 to the cable assembly 30. A solder tail 85 connects the board header 75 to the motherboard 10. Although FIG. 5 illustrates a through-hole mounted connector, a surface mounted connector would work as well. This enables the current cable assembly 30 to connect to any motherboard 10 no matter where the edge fingers 15 are located.

This invention provides a viable way to design an EMI shielded internal cable interconnect with the lowest possible cost to enable implementation of Intel's EXPRESSCARD in desktops. The one piece card edge style for the cable assembly makes it possible to eliminate the connectors on the motherboard or on the daughter card. The innovative scheme of terminating the metal can to the system ground makes it possible to shield only the cable assembly. All the shielding is on the cable assembly 30 and no shielding is on the edge fingers 15, 25 or the header 75.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. An internal cable assembly comprising:
shielded cable connectors located on either ends of the cable assembly;
edge fingers located directly on a system board, wherein the cable connector connects to the edge fingers on the system board.

2. The internal cable assembly of claim 1 wherein the system board is a motherboard.

3. The internal cable assembly of claim 1 wherein the system board is a daughter card.

4. The internal cable assembly of claim 1 wherein the shielded cable connectors include spring members stamped and formed on the cable connectors.

5. The internal cable assembly of claim 4 wherein the edge fingers include ground connections and contacts.

6. The internal cable assembly of claim 5 wherein the ground connections connect to the spring members of the shielded cable connectors.

7. The internal cable assembly of claim 5 wherein the ground connections extend beyond the contacts in the edge fingers.

8. The internal cable assembly of claim 6 wherein the ground connections are connected to ground through vias located on the ground connections.

9. The internal cable assembly of claim 1 further comprising a board header.

10. The internal cable assembly of claim 9 wherein the board header includes contact pads and a solder tail.

11. The internal cable assembly of claim 10 wherein the contact pads connect to the cable assembly.

12. The internal cable assembly of claim 10 wherein the solder tail connects the board header to the system board.
